(19) United States
(12) Patent Application Publication
(10) Pub. No.: US 2024/0125926 A1
(43) Pub. Date: Apr. 18, 2024

(54) Method and Device for Providing Training Data for Training a Data-Based Object Classification Model for an Ultrasonic Sensor System

(71) Applicant: Robert Bosch GmbH, Stuttgart (DE)

(72) Inventors: Juergen Schmidt, Sindelfingen (DE); Lena Bendfeld, Stuttgart (DE); Michael Tchorzewski, Boeblingen (DE); Tobias Wingert, Leonberg (DE); Tom Reimann, Bissingen An Der Teck (DE)

(21) Appl. No.: 18/483,688

(22) Filed: Oct. 10, 2023

(30) Foreign Application Priority Data
Oct. 18, 2022 (DE) 10 2022 210 990.2

(51) Int. Cl. G01S 15/08; G01S 15/58

(52) U.S. Cl. CPC G01S 15/08; G01S 15/588

(57) ABSTRACT

A method for providing training datasets for training an object classification model for object classification in an ultrasonic sensor system is disclosed. The method includes (i) providing one or multiple survey scenarios in which at least one surrounding object within a collection range of the ultrasonic sensor system is moved along a trajectory relative to the ultrasonic sensor system, (ii) collecting the ultrasonic signals reflected at the surrounding object at chronologically successive collection situations and respective identification of collection features depending on reflected ultrasonic signals collected during a respective collection situation, (iii) determining a candidate training dataset for each collection situation by associating a classification vector specified by the survey situation, the elements of which each indicate an object property of at least one surrounding object, with the collection features, and (iv) considering the candidate training dataset of each of the collection situations as a training dataset depending on the relative distance from the at least one surrounding object from the ultrasonic sensor system and the relative distances of the surrounding object from the ultrasonic sensor system during previously measured collection situations of candidate training datasets determined.

This application claims priority under 35 U.S.C. § 119 to patent application no. DE 10 2022 210 990.2, filed on Oct. 18, 2022 in Germany, the disclosure of which is incorporated herein by reference in its entirety.

The disclosure relates to ultrasonic sensor systems having data-based object classification models for classifying object properties of detected surrounding objects. The disclosure further relates to methods for providing training data for training such object classification models.

### BACKGROUND

Ultrasonic sensor systems, especially in vehicle applications, typically comprise a series of ultrasonic transducers that emit ultrasonic signals to receive and evaluate ultrasonic signals reflected from surrounding objects. In addition to complex methods for detecting the position or positions of surrounding objects, it is also necessary for vehicles or other mobile apparatuses to evaluate the objects in terms of their risk to driving operation. Usually, the surrounding objects are classified with regard to their collision relevance, which is determined in particular by their height above the ground or the roadway.

Previous approaches have used threshold values for the signal strength of the reflected ultrasound signal to suppress low objects early in the signal chain or decision trees that make use of a plurality of sensor parameters or object properties.

### SUMMARY

According to the disclosure, there are provided a method for providing training data for training the data-based object classification model for an ultrasonic sensor system as set forth below, and a corresponding device and ultrasonic sensor system as set forth below.

Further embodiments are specified below.

According to a first aspect, a method for providing training datasets for training an object classification model for object classification in an ultrasonic sensor system, comprising the following steps:
providing one or multiple survey scenarios in which at least one surrounding object within a collection range of the ultrasonic sensor system is moved along a trajectory relative to the ultrasonic sensor system;
collecting the ultrasonic signals reflected at the surrounding object at chronologically successive collection situations and respective identification of collection features depending on reflected ultrasonic signals collected in a respective collection situation;
determining a candidate training dataset for each collection situation by associating a classification vector specified by the survey situation, the elements of which each indicate an object property of at least one surrounding object, with the collection features;
considering the candidate training dataset of each of the collection situations as a training dataset depending on the relative distance of the surrounding object from the ultrasonic sensor system and the relative distances of the surrounding object from the ultrasonic sensor system during previously measured collection situations of candidate training datasets determined.

One candidate training dataset in particular is adopted as a training dataset depending on a density of collection situations with respect to a distance between the surrounding object and the ultrasonic sensor system.

Data-based object classification models can be used to classify the data on the surrounding objects collected using an ultrasonic sensor system. These are used to detect properties, such as traversability and collision relevance, on the basis of reflected ultrasonic signals or features derived from them. The quality and usability of data-based models (machine learning models) generally depends significantly on the quality of training datasets used to train them.

To provide such object classification models, training data must be collected in survey scenarios. The survey scenarios describe movement trajectories of one or multiple surrounding objects relative to the ultrasonic sensor system and are intended to cover collection situations where surrounding objects have different distances and orientations relative to the ultrasonic sensor system and different velocities relative to the ultrasonic sensor system. Each of the collection situations is associated with an object property of the respective surrounding object being classified.

A training dataset then comprises signal time series of the reflected ultrasonic sensor signals from the ultrasonic transducers and/or collection features derived or aggregated therefrom from the signal time series of the received reflected ultrasonic sensor signals, and the object property of the surrounding object corresponding to the reflected ultrasonic sensor signals. The object property can be specified by a classification vector, which in particular can comprise object properties of several surrounding objects.

To collect training datasets, various survey scenarios are simulated for one or multiple surrounding objects, each with known object properties, and the resulting reflected ultrasonic sensor signals are collected. Collection features are derived from the reflected ultrasonic sensor signals, and the object property or properties (known by specifying the collection situation) are associated with them in order to obtain a training dataset.

The collection of training datasets generally involves moving surrounding objects relative to the ultrasonic sensor system in one or multiple specified movement trajectories according to a respective survey scenario. During the movement of an object in the surroundings of the vehicle, ultrasonic sensor data is continuously collected and evaluated. In particular, the surveys are performed at regular collection timepoints.

In order to provide reliable object classification when applying the object classification model in all situations under all conditions of the surroundings, training datasets must be provided accordingly for these and similar collection situations. Various situations of object movements within the collection range of the ultrasonic sensor system are then usually simulated, which have different local references between the surrounding object and the ultrasonic sensor system, e.g., the detection angle, distance, and the like, as these affect the collection features derived from the ultrasonic sensor signals that are part of the training datasets and used for training the object classification model.

To ensure proper training of the object classification model, the training datasets must be homogeneously distributed over all collection situations to be evaluated. However, a homogeneous distribution of the training datasets is not possible if the variation of the density of the provided training datasets with respect to a local feature, such as the relative distance or the relative distance of the surrounding object from the ultrasonic sensor system, is very large. Nevertheless, in order to obtain a sufficient density of training datasets in all distance ranges to ensure reliable training throughout the collection range, a high number of training datasets would have to be collected. In this case, the trained object recognition model would be very complex.

Therefore, it is essential for the distribution of the collection features whether the surrounding object approaches relative to the vehicle at a uniform velocity, stops several times during the approach, or even briefly moves away again during the approach. Doing so specifically results in different numbers of training datasets for different distance ranges from surrounding objects, i.e., density differences of the distribution of training datasets with respect to distance. Therefore, it is necessary to use feature normalization to filter the training datasets so that, as far as possible, an equal distribution of training datasets results for the entire space of possible collection situations of the training datasets under consideration.

It can be provided that a candidate training dataset is only adopted as a training dataset if the distance in the corresponding collection situation lies within a distance range in which no training dataset has yet been identified using the survey scenario determined.

In order to avoid a higher density of training datasets for determined distance ranges than in other ranges, a rule-based selection of training datasets can be performed. In particular, over-representation of determined distance ranges by a changing movement trajectory of the surrounding object relative to the vehicle can be avoided by not considering partial sections of the movement trajectory when generating training datasets if they are traversed multiple times.

When a surrounding object moves with respect to the ultrasonic sensor system along a specified trajectory of movement, candidate training datasets can, e.g., therefore be collected for the various successively approached relative positions of the surrounding object. However, the candidate training datasets are only adopted as training datasets if they have been collected in a distance range in which no training datasets have previously been collected regarding the movement trajectory in question. In this way, a training dataset is provided for each distance range between the surrounding object and the ultrasonic sensor system.

When the surrounding object is approached along a movement trajectory, training datasets can therefore only be generated if the surrounding object is detected by the vehicle in a next collection step at a shorter distance (distance range associated with the shortest distance) than the previously stored shortest distance from the surrounding object.

Alternatively or additionally, it can also be provided that a surrounding object located in the vicinity of the vehicle predominantly moves away from the vehicle during the survey scenario. In this case, the training datasets are generated or updated only if the current distance of the surrounding object from the vehicle is greater than the previous maximum distance.

According to one embodiment, a candidate training dataset can be adopted as a training dataset weighted depending on a weighting, the weighting being determined depending on a relative velocity of the surrounding object and/or depending on an age of identification of the collection features in the respective collection situation.

The training datasets can therefore be normalized with respect to a change in velocity. For this purpose, in addition to the above selection of the candidate training datasets as training datasets, a normalization depending on the relative velocity between the surrounding object and the ultrasonic sensor system can be provided by weighting the training datasets according to the relative velocity of the surrounding object in question. Since more data points are collected for a determined distance range at slow velocities than at higher velocities for specified chronological collection steps, there is thus an accumulation of training datasets in determined distance ranges without the normalization. By compensating for the fact that features are considered with a lower weight at slow velocities of the surrounding object than at higher velocities, the influence of resulting accumulations of training datasets on the trained object classification model in determined distance ranges can be avoided.

The weighting can be taken into account in an inherently known manner known during the training by performing a normalization with respect to the existing training datasets.

In particular, candidate training datasets of the determined survey scenario can be adopted as training datasets if in each case the distance from the corresponding collection situation lies within a distance range in which at least one training dataset has already been identified using the determined survey scenario and whereby candidate training datasets have been identified multiple times for a proportion of distance ranges that exceeds a specified threshold proportion.

Further, a movement trajectory can be checked during the survey scenario to determine whether a proportion of an overlap of contiguous distance ranges in which candidate training datasets have been collected exceeds a specified threshold proportion. If the threshold proportion indicates that, e.g., the data for the total distance ranges of the ultrasonic sensor system's collection range have been collected two or more times by more than a specified proportion, e.g. 80%, then all candidate training datasets in that distance range can be considered.

These cases can occur when a survey scenario involves a surrounding object approaching, then briefly moving away from the vehicle again, and then continuing to approach the vehicle. Such a movement trajectory does not lead to an overweighting of training datasets or an increase in density of training datasets in a few distance ranges if there is a large overlap of distance ranges. Rather, the distance ranges are enriched with additional training datasets, and the amount of additional training datasets increases the feature quality.

Provision can be made to detect the conditions of the surroundings in determined distance ranges that can result in inferior quality reflected ultrasonic sensor signals, such as low sensitivities or external interference, these distance ranges are released to collect as many features or training datasets as possible. Within these ranges, candidate training datasets are not discarded.

Alternatively, the collection of further training datasets for the distance range in question can be allowed when the conditions of the surroundings improve.

In an alternative embodiment, the training datasets are not normalized during computation, but the individual training datasets are stored during the collection situation together with the distance from the surrounding object and a time stamp. At any timepoint, based on the previous history of a feature, a normalization can therefore be performed with respect to the detection distance using the frequency of detections for the corresponding distance range.

Additionally, timestamps can be used to provide more weighting to more recent entries, thus providing a degree of dynamicity for changing the conditions of the surroundings.

This weighting can be performed on several levels:
depending on an IIR filtering of the training datasets according to their creation timepoint, and/or
depending on a distance-dependent calculation of the training datasets with a stronger influence of more recent training datasets, and/or
situationally (e.g., when a specific dynamic is detected in the collection situation, e.g., due to a temperature change or when a fast movement is present), discarding the training datasets with strong history dependence.

Subsequently, the data-based object classification model can be trained using the training datasets, in particular taking into account the weighting, in an inherently known manner.

It can be further provided that the collection features are normalized prior to training. The normalization should be real-time capable so that the use of the object classification model is possible during the operation thereof. It is in this case essential that the collection features which the object classification model was trained with match the collection features derived from real ultrasound data during operation and obtained after appropriate normalization.

Similar to the normalization of the collection features for the provision of training datasets, the collection features being evaluated are also normalized when applying the object classification model. Doing so ensures that the data for model evaluation and training are the same.

### BRIEF DESCRIPTION OF THE DRAWINGS

Embodiments are explained in greater detail hereinafter with reference to the accompanying drawings. Shown are:

FIG. 1 an ultrasonic sensor system on a vehicle for collecting data on the surrounding objects;

FIG. 2 a flowchart illustrating a method for training an object classification model; and

FIG. 3 an example approach trajectory of a surrounding object for providing training datasets for training the object classification model.

### DETAILED DESCRIPTION

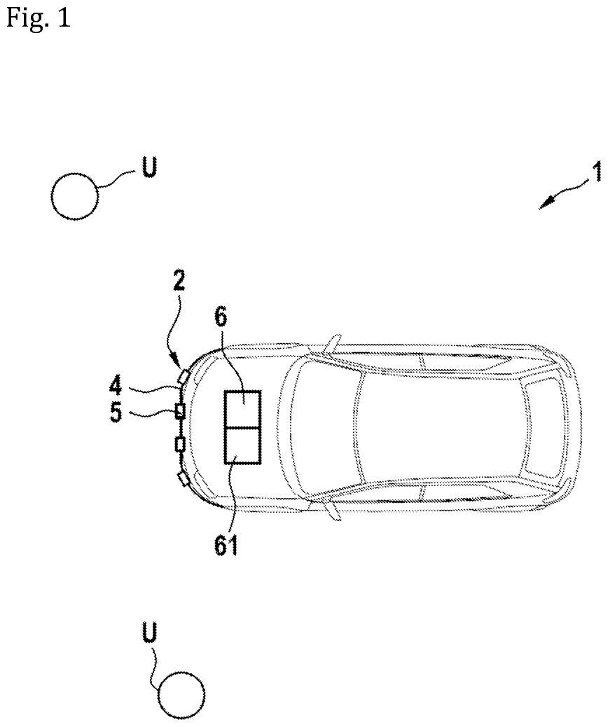

FIG. 1 shows a schematic representation of a vehicle 1 in the vehicle surroundings, in which one or multiple surrounding objects U can be located. The vehicle 1, by way of example a mobile apparatus, comprises an ultrasonic sensor system 2 arranged on a bumper 4. The ultrasonic sensor system 2 comprises multiple ultrasonic transducers 5 for emitting an ultrasonic sensor signal with signal pulses and for receiving ultrasonic sensor signals reflected from the surrounding objects U. The arrangement of the ultrasonic transducers 5 and the type of ultrasonic transducers 5 determine a configuration of the ultrasonic sensor system 2.

A control unit 6 is provided, which is used to evaluate the ultrasonic sensor signals from the ultrasonic transducers 5 of the ultrasonic sensor system 2. In the control unit 6, a data-based object classification model 61 is implemented in addition to a localization model for localizing the surrounding objects relative to the vehicle 1. The data-based object classification model 61 can comprise a neural network, a probabilistic regression model, a data-based decision tree, other machine learning model, or the like, which can be trained in a conventional manner or, e.g., via a gradient boosting algorithm.

The ultrasonic sensor signals of the ultrasonic transducers 5 are evaluated in a known manner using ultrasound-based localization methods to create a virtual map of the surroundings in the control unit 6 and to enter the positions of detected surrounding objects U there.

The object classification model 61 is trained with respect to the specified configuration of the ultrasonic sensor system 2. Said model has or will be trained to perform a classification of one or multiple surrounding objects U with respect to an object property, in particular their heights, primarily in order to distinguish whether the surrounding object in question can or cannot be driven over by the vehicle 1, i.e. is collision-relevant. The classification model 61 is for this purpose trained to identify, regarding one or multiple detected surrounding objects U, a classification result that associates an object property with each surrounding object U identified in the surroundings.

The detected surrounding objects are associated with classification results using the object classification model 61. The classification results classify the surrounding objects U according to the corresponding relevant object properties, in particular according to height classes.

The data-based object classification model 61 associates a classification vector with an input dataset, which can comprise one or multiple signal time series of the reflected ultrasound sensor signals from the ultrasound transducers 5 and/or collection features derived or aggregated therefrom. The collection features are appropriately normalized in a predetermined manner prior to model evaluation. The classification vector comprises elements, each of which is associated with an object property of a corresponding identified surrounding object.

When evaluating the object classification model 61, the value of the element indicates a probability that the object property associated with the class is realized by the surrounding object U pertaining to the class. By means of an argmax function applied to the elements of the classification vector associated with a surrounding object in each case, the object property determined by the element can be identified and signaled as a classification result for the model evaluation. The value of the element determined by argmax corresponds to the classification confidence.

Up to now, when training a data-based object classification model 61 for a new configuration of an ultrasonic sensor system 2, training datasets have generally had to be identified in a time-consuming manner by surveying the survey scenarios. For this purpose, survey scenarios are simulated and corresponding time series of ultrasonic sensor signals are recorded. On this basis, collection features are, e.g., generated by aggregation and input datasets are generated. The collection features are normalized in advance in the predetermined manner so that collection features normalized in the same way are available for training and model evaluation. The input datasets identified in this way are associated with a classification vector that specifies to each of the surrounding objects provided in the survey scenario the relevant object property of the surrounding object (known through the default of the survey scenario), usually in the form of a one-hot coded vector.

The object classification model 61 can be in the form of a neural network, or the like.

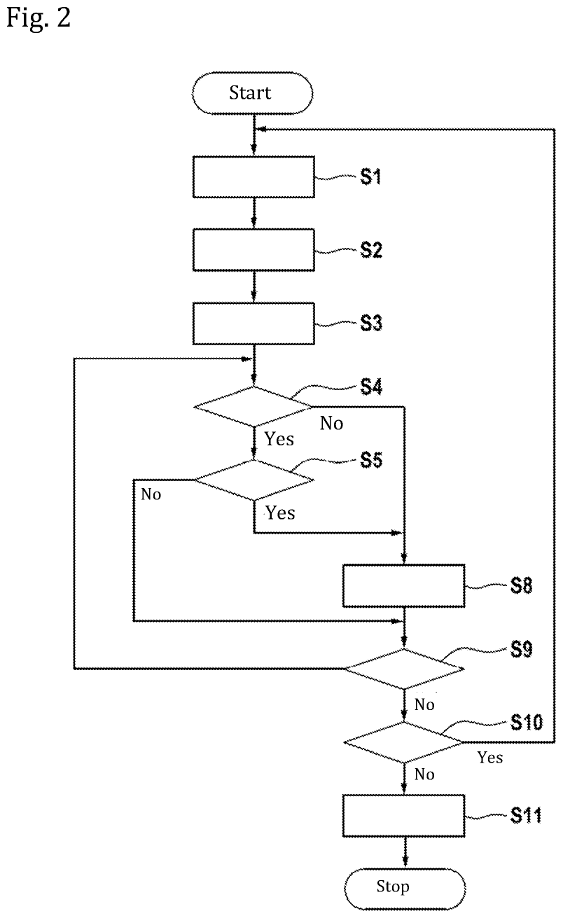

FIG. 2 schematically shows a flowchart illustrating a method for training an object classification model to recognize an object property. The method in FIG. 2 can be implemented as software or hardware in a conventional data processing apparatus and can in particular be performed offline, i.e., outside the vehicle in which the object classification model 61 is intended to be used.

For this purpose, in step S1, ultrasonic sensor signals are continuously transmitted and reflected ultrasonic sensor signals are collected by a test vehicle with an ultrasonic sensor system 2 in a survey scenario. The survey scenario provides for the movement of one or multiple surrounding objects along a respective movement trajectory within the collection range of the ultrasonic sensor system 2. The ultrasonic sensor signals are transmitted at successive collection timepoints (collection steps) at a constant time interval. At each of the collection timepoints, the distance of the surrounding object(s) from the ultrasonic sensor system 2 is known based on the previously known movement trajectory.

In step S2, the reflected ultrasonic sensor signals collected for each collection timepoint are evaluated in order to generate collection features. The collection timepoint generally corresponds to the timepoint when an ultrasonic survey is performed regarding a collection situation. Collection features represent aggregated information from the time series of reflected ultrasonic signals with respect to a collection timepoint, e.g., maximum signal amplitudes, features in the frequency range, features within the time range, and the like.

The collection features with respect to a collection timepoint are then each assigned a label in the form of an input variable vector during step S3 in order to accordingly obtain a candidate training dataset for each collection timepoint. The label indicates the object property of the surrounding object, in particular whether it is collision-relevant or traversable, which is known from the specified survey scenario. Part of the input quantity vector can be a distance of the surrounding object from the ultrasonic sensor system identified by a localization model. The label can be specified as a classification vector such that a high value of an element of the classification vector indicates the presence of the object property associated with the element and low values of an element indicate an absence of the object property associated with the element.

In step S4, it is sequentially checked whether a determined candidate training dataset can be adopted as a training dataset. The check provides for determining, for each collection situation of the current survey scenario, whether a training dataset has already been adopted/stored for the distance range associated with the distance of the surrounding object from the ultrasonic sensor system 2 or in which the distance lies with respect to the collection situation. The distance range generally corresponds to a defined range of distances within the collection range and can have a size of, e.g., between 5 cm-50 cm.

If a training dataset already exists in the distance range of the candidate training dataset (alternative: Yes), then the method continues with step S5. Otherwise (alternative: No), the method continues with step S8.

In step S5, it is checked whether a set of candidate training datasets covers a specified proportion of the distance ranges of the collection region multiple times, i.e., whether two candidate training datasets exist for a proportion of all distance ranges above a specified threshold proportion.

If this is the case (alternative: Yes), then the candidate training datasets are adopted as training datasets in step S8. Otherwise (alternative: No), the method continues with step S9.

The training datasets can be filtered with respect to a determined object and collection situation. For this purpose, it is intended to generate only a predetermined number of training datasets for different distance ranges of the surrounding object from the ultrasonic sensor system for a collection situation during which a surrounding object approaches or moves away from an ultrasonic sensor system. This allows the training datasets to be provided equally distributed over different distance ranges.

A simple 1st order velocity dependent low pass filter can be used for filtering a single collection feature:

a\hat{ }(t)=f(v)*a(t)+(1−f(v))*a\hat{ }(t−1)

where a(t) corresponds to a collection feature at a collection timepoint t and f(v) corresponds to a velocity-dependent filter constant.

This method is resource-saving, but has the disadvantage that each distance range can only be evaluated once and the collection features must remain frozen the second time a distance range is traversed.

Alternatively, a histogram can be created over the distance and the weight of each entry depends on the number of entries existing in the surroundings (sliding window). To integrate the time dependence here, the histogram can be emptied over time, e.g. 0.1 bins/500 ms. The method would be resource intensive, but it could use all data even with multiple detections of determined distance ranges.

Furthermore, the training datasets can also be considered with a weighting during the later training. The weighting provides that training datasets with a higher weight are considered more in the training of the object classification model than training datasets with a lower weight. It can be provided that training datasets in distance ranges where the surrounding object has a low velocity are weighted lower than training datasets that are weighted higher for objects in a distance range where the surrounding object has a higher velocity. It can therefore be ensured that a comparable number of training datasets are considered for the different distance ranges for a determined surrounding object in a determined survey scenario.

In step S8, the candidate training dataset is saved as a training dataset and added to the set of training datasets for training the object classification model.

In particular, this means that for movement trajectories in which the approach of the object causes the object to briefly move away from the ultrasonic sensor system again and then continue to approach, the range of overlapping can only be taken into account in a simple manner. Alternatively, for this purpose, the training datasets that are more recent can be stored preferentially and the one previously stored for the distance range in question can be discarded.

In step S9, a check is made to see if there is at least one other candidate training dataset. If yes, the method continues with step S4. Otherwise (alternative: No), the method continues with step S10.

In step S10, it is checked whether another survey scenario is intended to be surveyed. If yes, the method continues with step S1. Otherwise (alternative: No), the method continues with step S11.

In step S11, the data-based object classification model is trained using the stored training data sets in an inherently known manner. The object classification model can be provided for this purpose in the form of a neural network or a corresponding other data-based model.

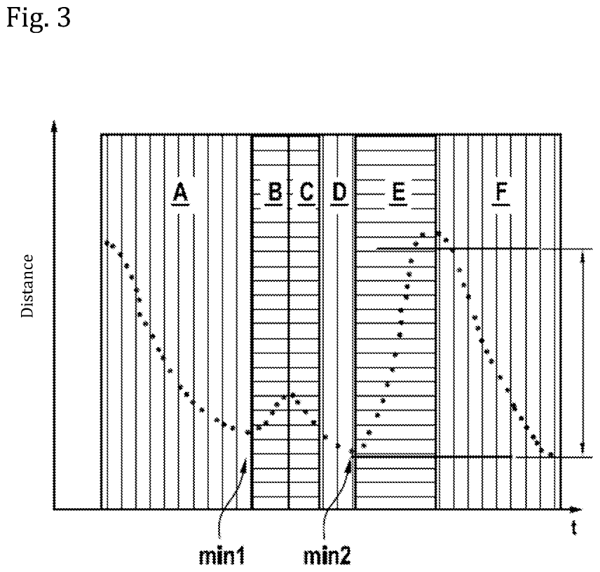

FIG. 3 shows an example of a surveying scenario in which a surrounding object is moved within the collection range of an ultrasonic sensor system 2. The points represent surveys at the collection timepoints. Shown is an approach maneuver of a surrounding object U (relative) with respect to an ultrasonic sensor system 2 and the associated detection distances (ranges). Within ranges A, C, G, and F, the vehicle approaches the surrounding object, i.e., the relative distance between vehicle 1 and surrounding object U decreases, and in ranges B and E, vehicle 1 moves away from surrounding object U.

Within range A, the vehicle approaches the surrounding object U for the first time, and all detection distances have not been measured before. Collection features are generated accordingly and candidate training datasets and training datasets are generated from them. Within ranges B and E, the vehicle moves away, during the moving away the resulting candidate training datasets are discarded to avoid having too many training datasets for one determined distance range.

Within range C, there is also no collection of training datasets because the detection distance is greater than the previous minimum, marked min1. Within range D, the candidate training datasets are again adopted because the detection distance is again below the previous minimum min1.

Within range F, training datasets are again collected, even though the detection is above the previous minimum (min2) because the distance difference between the current detection distance and previous minimum is above a specified threshold value.

In an alternative embodiment, the training datasets can be collected regularly for all distance ranges and, in a subsequent evaluation, the candidate training datasets can be selected with respect to their detection distances and time stamps. According to the frequency of detection for each distance range, a weighting of the candidate training datasets can take place, so that training datasets in distance ranges with many collections are assigned a lower weight than training datasets in distance ranges with a lower number of collections. Weighting can be performed by multiplying the label or classification vector by a weighting factor. Alternatively or additionally, weighting can be performed depending on the age of the respective training dataset, so that younger training datasets are given a higher weight than older training datasets, so that some dynamics for changing the conditions of the surroundings can be taken into account.

What is claimed is:

1. A method for providing training datasets for training an object classification model for object classification in an ultrasonic sensor system, comprising:
providing one or multiple survey scenarios in which at least one surrounding object within a collection range of the ultrasonic sensor system is moved along a trajectory relative to the ultrasonic sensor system;
collecting the ultrasonic signals reflected at the surrounding object at chronologically successive collection situations and respectively identifying collection features depending on reflected ultrasonic signals collected during a respective collection situation;
determining a candidate training dataset for each collection situation by associating a classification vector specified by the survey situation, the elements of which each indicate an object property of at least one surrounding object, with the collection features; and
considering the candidate training dataset of each of the collection situations as a training dataset depending on the relative distance from the at least one surrounding object from the ultrasonic sensor system and the relative distances of the surrounding object from the ultrasonic sensor system during previously measured collection situations of determined candidate training datasets.

2. The method according to claim 1, wherein a candidate training dataset is selected as a training dataset depending on a density of collection situations with respect to a distance between the surrounding object and the ultrasonic sensor system.

3. The method according to claim 1, wherein a candidate training dataset is adopted as a training dataset only if the distance from the corresponding collection situation lies within a distance range within which no training dataset has yet been identified using the survey scenario determined.

4. The method according to claim 3, wherein:
candidate training datasets of the survey scenario determined are adopted as training datasets if in each case the distance from the corresponding collection situation lies within a distance range in which at least one training dataset has already been identified using the survey scenario determined, and
candidate training datasets have been identified multiple times for a proportion of distance ranges that exceeds a specified threshold proportion.

5. The method according to claim 1, wherein:
a candidate training dataset is provided with a weighting as a training dataset, and
the weighting is determined depending on a relative velocity of the surrounding object and/or depending on an age of the identification of the collection features in the respective collection situation.

6. The method according to claim 1, wherein the data-based object classification model is trained using the training datasets.

7. The method according to claim 1, wherein the collection features of the training datasets are normalized.

8. A device for performing the method according to claim 1.

9. A computer program product comprising instructions that, when the program is executed by at least one data processing apparatus, prompt the latter to perform the steps of the method according to claim 1.

10. A machine-readable storage medium comprising instructions that, when executed by at least one data processing apparatus, prompt the latter to perform the steps of the method according to claim 1.

11. The method according to claim 1, wherein the method is an at least partially computer-implemented method.

12. The method according to claim 1, wherein the data-based object classification model is trained using the training datasets taking into account the weighting.
